(19) United States
(12) Patent Application Publication
(10) Pub. No.: US 2021/0302029 A1
(43) Pub. Date: Sep. 30, 2021

(54) ELEVATED COUNTERTOP COOKING APPARATUS

(71) Applicant: IANTORNO 2019 FAMILY TRUST, Vaughan (CA)

(72) Inventor: Salvatore Albano IANTORNO, Maple (CA)

(21) Appl. No.: 16/835,676

(22) Filed: Mar. 31, 2020

(51) Int. Cl. F24C 15/32; H05B 3/40; H05B 3/00; H05B 3/14; F24C 15/02; F24C 7/08; A47J 37/06

(52) U.S. Cl. CPC F24C 15/325; H05B 3/40; H05B 3/0076; A47J 37/0641; F24C 15/02; F24C 7/082; H05B 3/141

(57) ABSTRACT

There is provided a cooking apparatus for cooking food items, the cooking apparatus dimensioned to be placed on a kitchen countertop, the cooking apparatus including: a housing including a top side, a bottom side, a front side, a rear side, a first elevated side, and a second elevated side; a plurality of cooking compartments each defining a cooking cavity and including a heating element, each cooking compartment defining an opening to the cooking cavity for receiving one or more of the food items to be cooked by the respective heating element, the respective openings of the cooking compartments are vertically spaced along the front side in a stacked arrangement; and a cooking control to control operation of the cooking compartments

### TECHNICAL FIELD

The following relates generally to cooking apparatuses, and more specifically, to an elevated countertop cooking apparatus.

### BACKGROUND

Countertop cooking apparatuses are useful devices to cook food items without having to engage large, energy expensive, apparatuses like full ovens. Countertop cooking apparatuses are generally portable and more energy efficient, especially for cooking smaller food items. However, in many kitchens and cooking establishments, countertop area is at a premium, and thus the use of countertop cooking apparatuses may be limited.

### SUMMARY

In an aspect, there is provided a cooking apparatus for cooking food items, the cooking apparatus dimensioned to be placed on a kitchen countertop, the cooking apparatus comprising: a housing comprising a top side, a bottom side, a front side, a rear side, a first elevated side, and a second elevated side; a plurality of cooking compartments each defining a cooking cavity and comprising a heating element, each cooking compartment defining an opening to the cooking cavity for receiving one or more of the food items to be cooked by the respective heating element, the respective openings of the cooking compartments are vertically spaced along the front side in a stacked arrangement; and a cooking control to control operation of the cooking compartments.

In a particular case, the area of the bottom side is less than the area of the front side.

In another case, the bottom side is equal to or less than half the area of the front side.

In yet another case, a door is affixed to each opening to restrict access to the cooking compartment.

In yet another case, each cooking compartment comprises an automated turntable to rotate food items.

In yet another case, each cooking compartment comprises an urging mechanism for urging the food item towards the opening.

In yet another case, the heating element comprises at least one of radiant heating coils, a ceramic heater, a halogen cooking lamp, and a sheath heater.

In yet another case, each cooking compartment comprises a convection fan directed to blow air over the heating element or the food item, or both.

These and other aspects are contemplated and described herein. It will be appreciated that the foregoing summary sets out representative aspects of the embodiments to assist skilled readers in understanding the following detailed description.

### DESCRIPTION OF THE DRAWINGS

A greater understanding of the embodiments will be had with reference to the Figures, in which:

FIG. 1 illustrates a front perspective view of an embodiment of an elevated countertop cooking apparatus;

FIG. 2 illustrates a front elevation view of the elevated countertop cooking apparatus of FIG. 1;

FIG. 3 illustrates a rear elevation view of the elevated countertop cooking apparatus of FIG. 1;

FIG. 4 illustrates a top view of the elevated countertop cooking apparatus of FIG. 1; and

FIGS. 5A to 5G illustrate front elevation views of other respective embodiments of the elevated countertop cooking apparatus.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

The following relates generally to cooking apparatuses, and more specifically, to an elevated countertop cooking apparatus.

The cooking apparatus of the embodiments described herein advantageously provides multiple cooking compartments in an elevated arrangement. This arrangement significantly reduces countertop footprint, while allowing multiple food items to be cooked simultaneously, and in some cases, independently. In many kitchens and cooking establishments where countertop area is at a premium, the present embodiments provide a substantially advantageous solution for applications that require multiple cooking chambers.

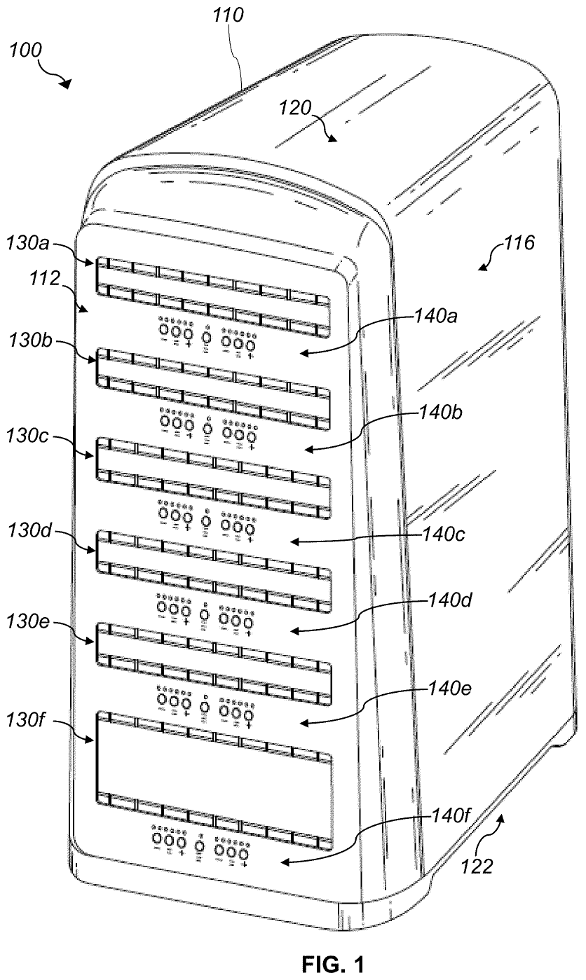

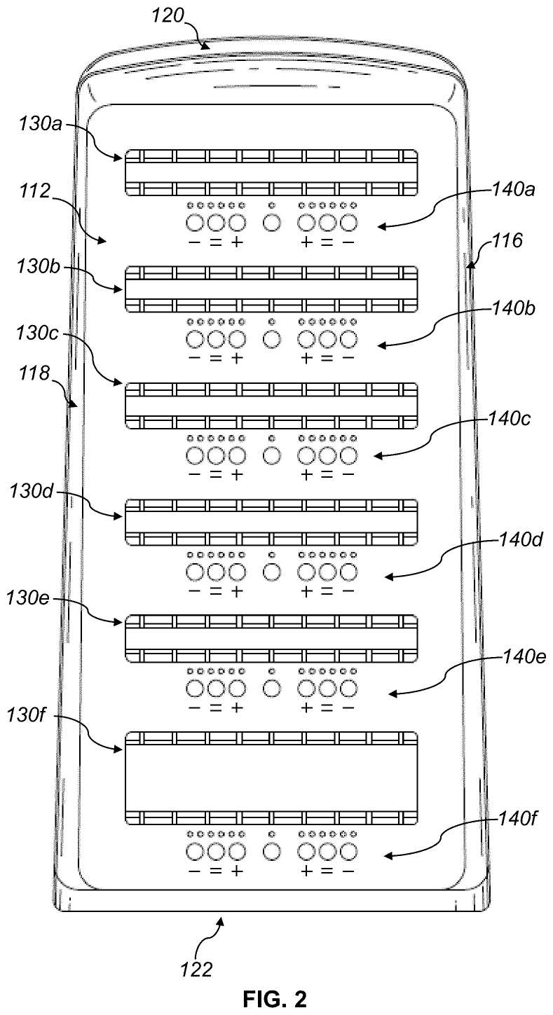

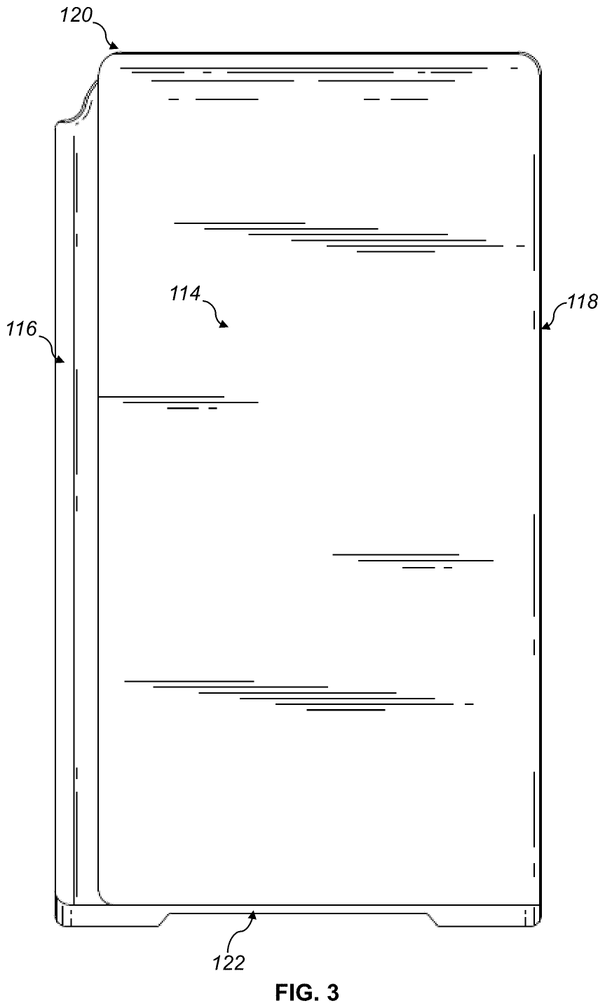

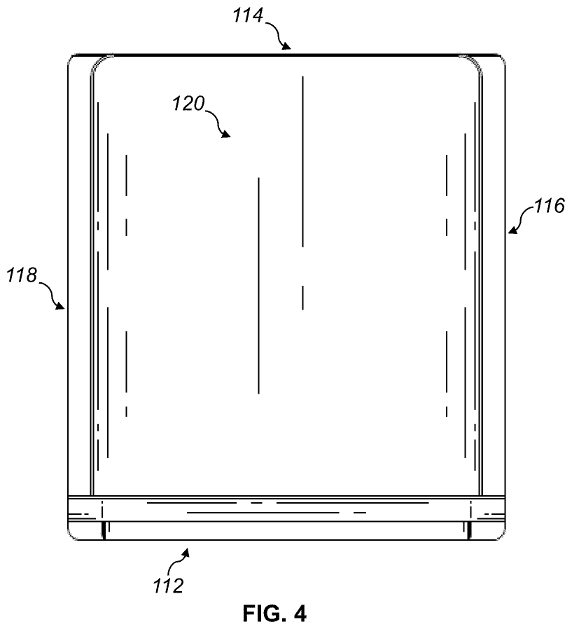

Turning to FIG. 1, a front perspective view of an embodiment of an elevated countertop cooking apparatus 100 is illustrated. FIG. 2 illustrates a front elevation view, FIG. 3 illustrates a rear elevation view, and FIG. 4 illustrates a top view of the elevated countertop cooking apparatus 100.

The cooking apparatus 100 includes a housing 110 having a front side 112, a rear side 114, a first elevated side 116, and a second elevated side 118, a top side 120, and a bottom side 122. In the embodiment of FIGS. 1 to 4, the bottom side 122 has an area that is slightly larger than the top side 120 due to tapering as the elevation increases; however, in further cases, the top side 120 can be the same area, or have a greater area, than the bottom side 122. In the present embodiments, the area of the bottom side 122 is less than the area of the front side 112; as an example, the bottom side 122 can be approximately half the area of the front side 112, three-quarters the area of the front side 112, or the like. In this way, the countertop area required by the cooking apparatus 100, defined by the area of the bottom side 122, is less than the area required to provide multiple cooking compartments, which are located on the front side 112. The present embodiments can have any suitable width, depth, and height as long as the cooking apparatus is dimensioned to be suitably placeable on a kitchen countertop.

The front side 112 includes multiple cooking compartments 130. In the embodiments of FIGS. 1 to 4, there are six cooking compartments 130a to 130f, respectively. The cooking compartments 130 are arranged in a vertically stacked arrangement, where each cooking compartment 130 is spaced relative to other cooking compartments 130 along the vertical. In this way, multiple cooking compartments 130 can be included without increasing the countertop footprint.

Each cooking compartment 130 includes an opening on the front side 112 for receiving a food item to be cooked, and for retrieving such food item after cooking. In some cases, a door or flap (not shown) can be affixed to the opening to restrict access to the cooking compartment 130, such as while the food is cooking. The cooking compartments 130, and by extension the respective openings, can be any suitable size; for example, the embodiment of FIGS. 1 to 4 includes two sizes of cooking compartments 130, a first size of compartments 130a, 130b, 130c, 130d, 130e and a larger second size of compartment 130f. In some cases, the size of the cooking compartments 130, and their respective openings, can be sized for particular food items to be cooked (for example bread slices) or sized for certain cooking utensils (for example, an associated baking tray).

The cooking compartments 130 can have any suitable interior construction, for example, constructed out of aluminum, stainless steel, or heat resistant polymer. In some cases, the cooking compartments 130 can include an automated turntable for rotating food items inside the cavity. In some cases, the cooking compartments 130 can include an urging mechanism, for example a spring releasable carriage, for urging the food item towards the opening after the cooking process has completed.

The cooking compartments 130 can heat and cook food items using any suitable heating element or heating approach. For example, including radiant heating coils inside or adjacent to the cooking compartment 130. In further cases, a ceramic heater, halogen cooking lamp, sheath heater, or the like, can be used. In some cases, a convection fan can be provided in the cooking compartment 130 directed to blow air over the heating element and/or the food items. In some cases, multiple types of heating elements can be used for each cooking compartment 130.

In the embodiment of FIGS. 1 to 4, each cooking compartment 130 is controlled by a separate cooking control 140a to 140f. Each cooking control 140 controls the operation of the respective cooking compartment 130, such as operation status, duration, temperature, and the like. In some cases, each cooking control 140 can include an output device, such as LED lights, an LED display, or a touchscreen, to indicate to a user the status, or aspects, of the cooking process. In some cases, each cooking control 140 can include an input device, such as buttons or a touchscreen, to allow the user to initiate the cooking process and, in some cases, control aspects of the cooking process. In further cases, a single cooking control 140 can control multiple, or all, cooking compartments 130. In further cases, other cooking controls 140 can be used; for example remote control of the cooking compartments using an app on a smartphone communicating with a receiver or computing device associated with control over each, or all, of the cooking compartments 130.

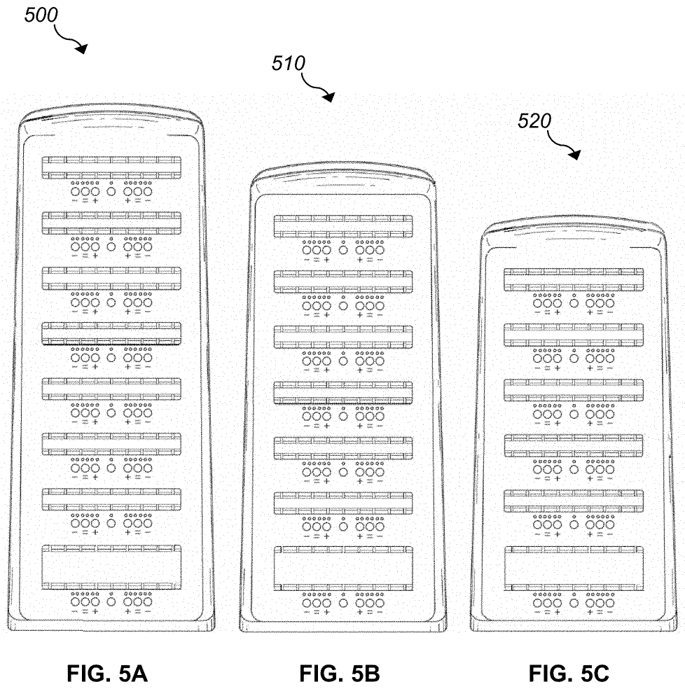

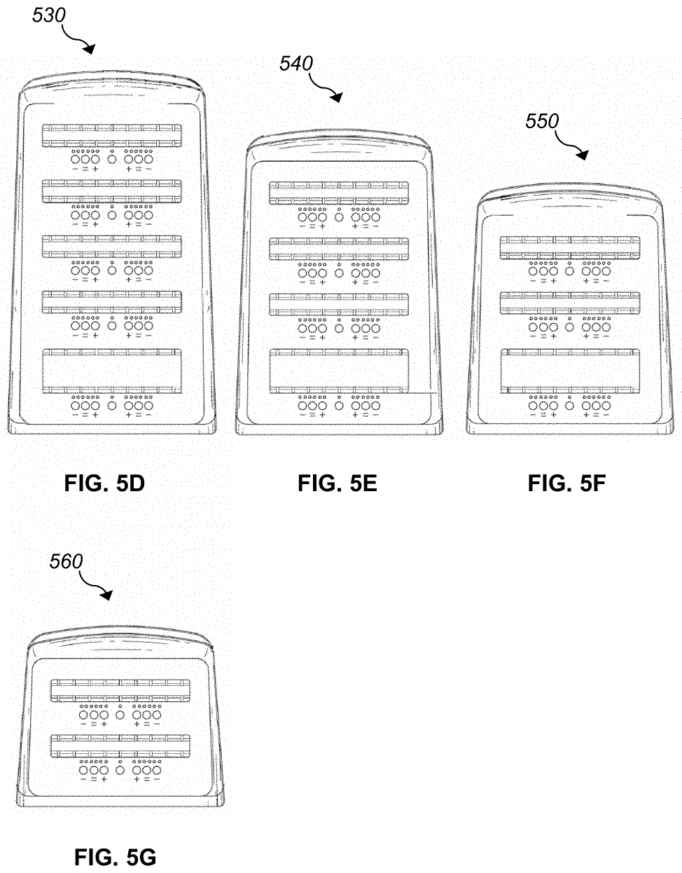

FIGS. 5A to 5G illustrate front elevation views of other respective embodiments of the elevated countertop cooking apparatus 500, 510, 520, 530, 540, 550, and 560 respectively. As illustrated, different quantities, types, and configurations of cooking compartments 130 are contemplated as part of the various embodiments. While the present embodiments illustrate between two and eight cooking compartments 130, any suitable quantity of vertically separated cooking compartments 130 can be used.

Although the foregoing has been described with reference to certain specific embodiments, various modifications thereto will be apparent to those skilled in the art without departing from the spirit and scope of the invention as outlined in the appended claims.

1. A cooking apparatus for cooking food items, the cooking apparatus dimensioned to be placed on a kitchen countertop, the cooking apparatus comprising:
a housing comprising a top side, a bottom side, a front side, a rear side, a first elevated side, and a second elevated side;
a plurality of cooking compartments each defining a cooking cavity and comprising a heating element, each cooking compartment defining an opening to the cooking cavity for receiving one or more of the food items to be cooked by the respective heating element, the respective openings of the cooking compartments are vertically spaced along the front side in a stacked arrangement; and
a cooking control to control operation of the cooking compartments.

2. The cooking apparatus of claim 1, wherein the area of the bottom side is less than the area of the front side.

3. The cooking apparatus of claim 2, wherein the bottom side is equal to or less than half the area of the front side.

4. The cooking apparatus of claim 1, wherein each cooking compartment further comprises a door affixed in front of the respective opening to restrict access to the cooking compartment.

5. The cooking apparatus of claim 1, wherein each cooking compartment comprises an automated turntable to rotate food items.

6. The cooking apparatus of claim 1, wherein each cooking compartment comprises an urging mechanism for urging the food item towards the opening.

7. The cooking apparatus of claim 1, wherein the heating element comprises at least one of radiant heating coils, a ceramic heater, a halogen cooking lamp, and a sheath heater.

8. The cooking apparatus of claim 1, wherein each cooking compartment comprises a convection fan directed to blow air over the heating element or the food item, or both.
